(19) United States
(12) Patent Application Publication
(10) Pub. No.: US 2026/0034957 A1
(43) Pub. Date: Feb. 5, 2026

(54) SEATING DEVICE FOR VEHICLE

(71) Applicant: TOYOTA JIDOSHA KABUSHIKI KAISHA, Aichi-ken (JP)

(72) Inventors: Akira KANEKO, Toyota-shi (JP); Daishi TAKATA, Nagoya-shi (JP)

(21) Appl. No.: 19/258,898

(22) Filed: Jul. 3, 2025

(30) Foreign Application Priority Data
Aug. 1, 2024 (JP) 2024-125679

(51) Int. Cl. B60R 22/02; B60N 2/22

(52) U.S. Cl. CPC B60R 22/02; B60N 2/2231; B60R 2022/028

(57) ABSTRACT

A seating device for a vehicle including a vehicle seat and a seat belt, wherein the vehicle seat includes a side frame, a seat back frame, and a reclining mechanism for inclining the seat back rearward, and a belt buckle and a belt anchor of the seat belt are coupled to a bracket.

### CROSS REFERENCE TO RELATED APPLICATION

This application claims priority to Japanese Patent Application No. 2024-125679 filed on Aug. 1, 2024, which is incorporated herein by reference in its entirety including the specification, claims, drawings, and abstract.

### TECHNICAL FIELD

The present disclosure relates to a structure of a vehicle seating device including a vehicle seat and a seat belt.

### BACKGROUND

There has been used a vehicle seat that suppresses positional displacement of a head of an occupant with respect to a headrest and roll-up of clothes of the occupant when a seatback is tilted rearward.

For example, JP 2006-160217A discloses a vehicle seat including a coupling link that rotatably couples a lower portion of a seat back and a rear end portion of a seat cushion, and a parallel link that couples the seat cushion and a floor, wherein the rear end portion of the seat cushion is displaced upward and rearward when the seat back is tilted rearward.

Further, J P 2010-246599A discloses a vehicle seat in which a seat back and a seat cushion are connected by a link mechanism including an L-shaped link, and when the seat back is tilted rearward, the seat cushion moves upward and forward.

### SUMMARY

In the vehicle seat of the related art, occupant support (restriction) by the lap belt when the seat back is tilted backward is not considered. That is, since the movable range of the installation position of the belt buckle or the belt anchor is extremely small, the belt cannot be fixed following the seatback inclination angle. In particular, when the position of the lap belt does not follow the seatback inclination angle, the upper anterior iliac spine cannot be supported by the lap belt, and the submarine phenomenon in which the body of the occupant slips down to the seat front side at the time of a vehicle collision, for example, a frontal collision (frontal collision) cannot be sufficiently suppressed in some cases.

Therefore, an object of the present disclosure is to provide a seating device for a vehicle that can sufficiently support an occupant even in a state where a seatback is tilted rearward.

A vehicle seating device according to an embodiment of the present disclosure includes a vehicle seat and a seat belt for restraining a vehicle occupant seated on the vehicle seat. The vehicle seat includes a side frame configured to support a seat cushion, a seat back frame configured to support a seat back, and a reclining mechanism. The reclining mechanism includes a curved bracket integrally mounted on the seat back frame, the bracket is configured to move arcuately with respect to the side frame to thereby tilt the seat back rearwardly. The seat belt includes a belt buckle and a belt anchor, and the belt buckle and the belt anchor are coupled to the bracket.

Thus, when the seat back is tilted backward, the positions of the belt buckle and the belt anchor of the seat belt move in accordance with the inclination angle of the body of the occupant, so that the position of the seat belt with respect to the body of the occupant is kept substantially constant. Therefore, it is possible to sufficiently support the occupant even in a state in which the seat back is tilted backward.

In the seating device for the vehicle according to the present disclosure, the reclining mechanism may include a curved rail attached to the side frame, the bracket may be configured to move while being guided by the curved rail, so as to be swung around the center of curvature of the curved rail, the curved rail may be attached to the side frame with the center of curvature being located away from the side frame or the bracket.

Accordingly, the reclining mechanism can be disposed at a position away from the rotation center while setting the rotation center at a position close to the hip point of the occupant. Accordingly, it is possible to suppress the occupant sitting on the vehicle seat from coming into contact with the reclining mechanism.

According to the present disclosure, it is possible to provide a seating device for a vehicle capable of sufficiently supporting an occupant even in a state in which a seatback is tilted backward.

### BRIEF DESCRIPTION OF DRAWINGS

FIG. 1 is a left elevational view of a vehicle seating device according to an embodiment of the present disclosure;

FIG. 2 is a right elevational view of the vehicle seating device according to the embodiment;

FIG. 3 is an elevational view showing a state in which a seat back of the vehicle seating device shown in FIG. 1 is inclined rearward;

FIG. 4 is an elevational view showing a state in which a seatback of the vehicle seating device according to the comparative example is inclined rearward.

### DESCRIPTION OF EMBODIMENTS

Hereinafter, a vehicle seating device 100 according to an embodiment will be described with reference to the drawings. Note that FR, UP, and RH shown in the drawings indicate a front side, an upper side, and a right side of the vehicle seating device 100, respectively. The opposite directions of FR, UP, and RH indicate the rear side, the lower side, and the left side, respectively. Hereinafter, in the case where the front-rear direction, the left-right direction, and the up-down direction are simply used, the front-rear direction, the left-right direction, and the up-down direction of the vehicle seating device 100 are indicated unless otherwise specified.

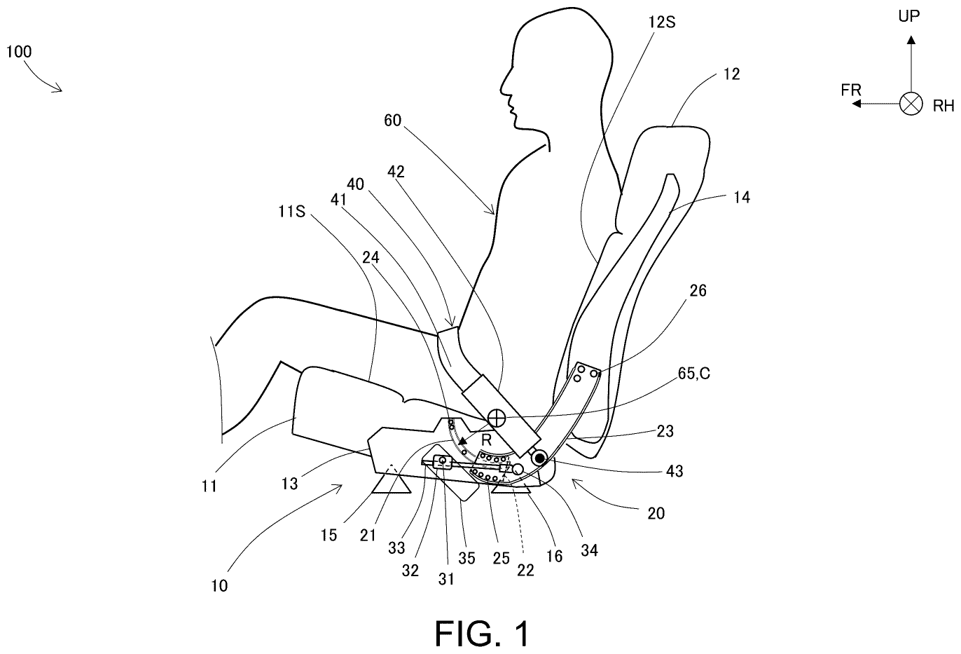

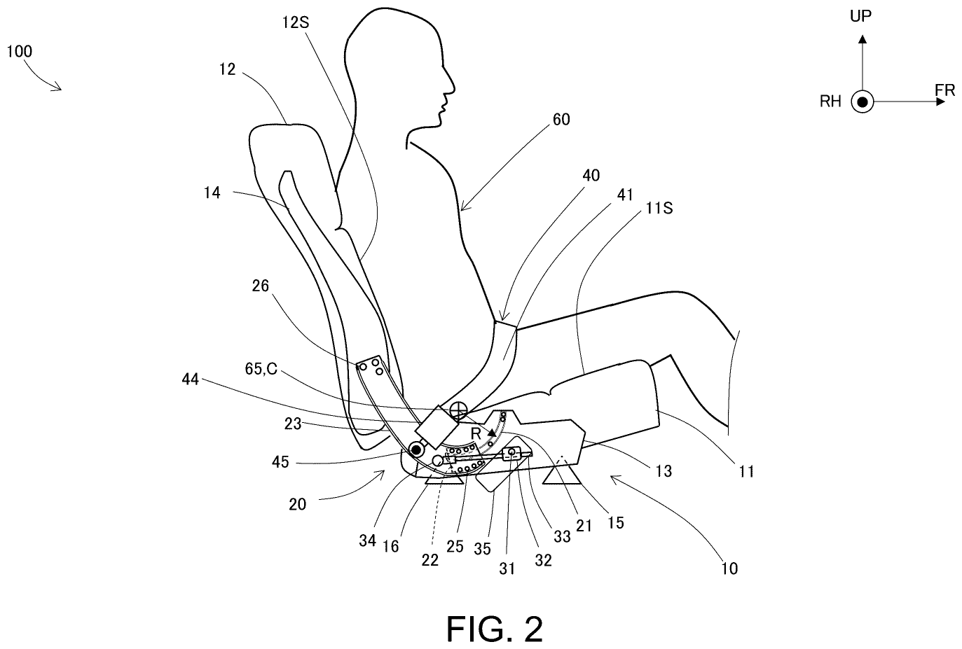

As shown in FIGS. 1 and 2, the vehicle seating device 100 includes a vehicle seat 10 and a seat belt 40.

The vehicle seat 10 includes a seat cushion 11, a seat back 12, a side frame 13, a seat back frame 14, and a reclining mechanism 20.

The side frame 13 is a part of a seat cushion frame that supports the seat cushion 11. The side frame 13 is a metal plate-shaped member that is disposed at the left and right end portions of the vehicle seat 10 and extends in the front-rear direction. The left and right side frames 13 are connected to the left and right by a plurality of cross members (not shown), and are attached to a floor (not shown) of the vehicle body by front and rear leg portions 15 and 16. The seat cushion 11 is mounted on the left and right side frames 13. The seat cushion 11 includes a seat surface 11S that supports the buttocks of the seated occupant 60.

The seat back frame 14 is a metal plate-shaped member that is disposed on the upper rear side of the left and right side frames 13 and extends in the vertical direction. The left and right seat back frames 14 are connected to each other in the left-right direction by connecting members (not shown). The left and right seat back frames 14 are connected to the left and right side frames 13 by a reclining mechanism 20. A seat back 12 is attached to the front of the left and right seat back frames 14. The seat back 12 includes a support surface 12S that supports the back of the seated occupant 60.

The reclining mechanism 20 includes a curved rail 21, a slider 22, a bracket 23, a rod 31, a worm gear case 32, a screw 33, and a motor 35. The reclining mechanism 20 tilts the seat back 12 rearward about the rotation center C. Here, the rotation center C is a position away from the reclining mechanism 20 and close to the hip point 65 which is the center of rotation of the upper body of the occupant 60 when the seat back 12 is tilted backward.

The curved rail 21 is an arc-shaped rail having a radius R and attached to the side surface of the side frame 13 by a bolt 24. The slider 22 is movable along the curved rail 21 while being guided by the curved rail 21. The bracket 23 is a curved plate-shaped member having a lower portion curved in an arc shape and an upper portion extending upward. An upper portion of the bracket 23 is fixed to a side surface of a lower portion of the seat back frame 14 by a bolt 26. Thus, the bracket 23 and the seat back frame 14 are integrated with each other. The lower portion of the bracket 23 is fixed to the slider 22 by bolts 25. Therefore, when the slider 22 is guided by the curved rail 21 and moves in an arc shape, the lower portion of the bracket 23 rotationally moves with respect to the side frame 13, and the seat back frame 14 rotates about the rotation center C. As a result, the seat back 12 tilts rearward. Here, the rotation center C is a curvature center of the curved rail 21. In this way, the curved rail 21 is attached to the side frame 13 so that the center of curvature thereof is at a position away from the side frame 13 or the bracket 23.

The rod 31 is a round bar member that is supported by the left and right side frames 13 and extends in the left-right direction. The left and right end portions of the rod 31 extend to the outside of the left and right side frames 13 through the left and right side frames 13. The worm gear case 32 accommodates a worm gear connected to both ends of the rod 31 and a screw 33. The worm gear engages with the screw 33 in the worm gear case 32. The worm gear case 32 is attached to the outside of the side frame 13 so as to be rotatable around the rod 31. The rear end of the screw 33 is rotatably connected to the lower portion of the bracket 23 by a fastening portion 34. The motor 35 is disposed between the left and right side frames 13 to rotationally drive the rod 31.

The seat belt 40 includes a belt main body 41, a belt buckle 42, and a belt anchor 44. In the case of the right seat, the belt buckle 42 is rotatably fastened to the fastening point 43 of the left bracket 23 of the vehicle seat 10. In the case of the right seat, the belt anchor 44 is rotatably fastened to the fastening point 45 of the right bracket 23 of the vehicle seat 10. In addition, in the case of the left-side sheet, the arrangement of these sheets is reversed from that of the right-side sheet.

As shown in FIGS. 1 and 2, in the upright state of the seat back 12, the seat belt 40 supports the upper anterior iliac spine of the occupant 60.

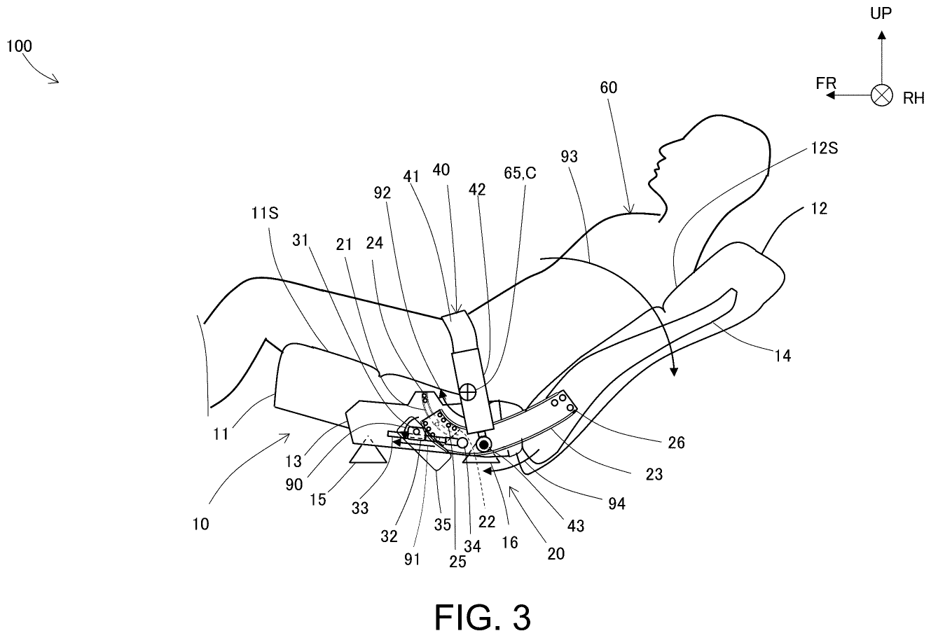

Next, an operation of the seat back 12 inclining rearward will be described with reference to FIG. 3.

When the rod 31 is rotated by the motor 35, the worm gears connected to both ends of the rod 31 are rotated as indicated by arrows 90 in FIG. 3. As a result, as indicated by an arrow 91 in FIG. 3, the screw 33 engaged with the worm gear moves forward with respect to the side frame 13. Accordingly, the fastening portion 34 at the rear end of the screw 33 moves forward. When the fastening portion 34 moves forward, the slider 22 moves in an arc along the curved rail 21 as indicated by an arrow 92 in FIG. 3. As a result, as indicated by an arrow 93 in FIG. 3, the seat back 12 rotates about the rotation center C and tilts rearward.

At this time, the fastening point 43 of the belt buckle 42 of the left bracket 23 moves forward in an arc shape together with the left bracket 23 as indicated by an arrow 94 in FIG. 3. Similarly, the fastening point 45 of the belt anchor 44 of the right bracket 23 moves forward in an arc shape together with the right bracket 23. As a result, the position of the belt main body 41 with respect to the occupant 60 is kept substantially constant. Thus, even when the seat back 12 is tilted backward, the belt main body 41 can support the upper anterior iliac spine of the occupant 60. Therefore, the vehicle seating device 100 can sufficiently support the occupant 60 even in a state in which the seat back 12 is tilted rearward.

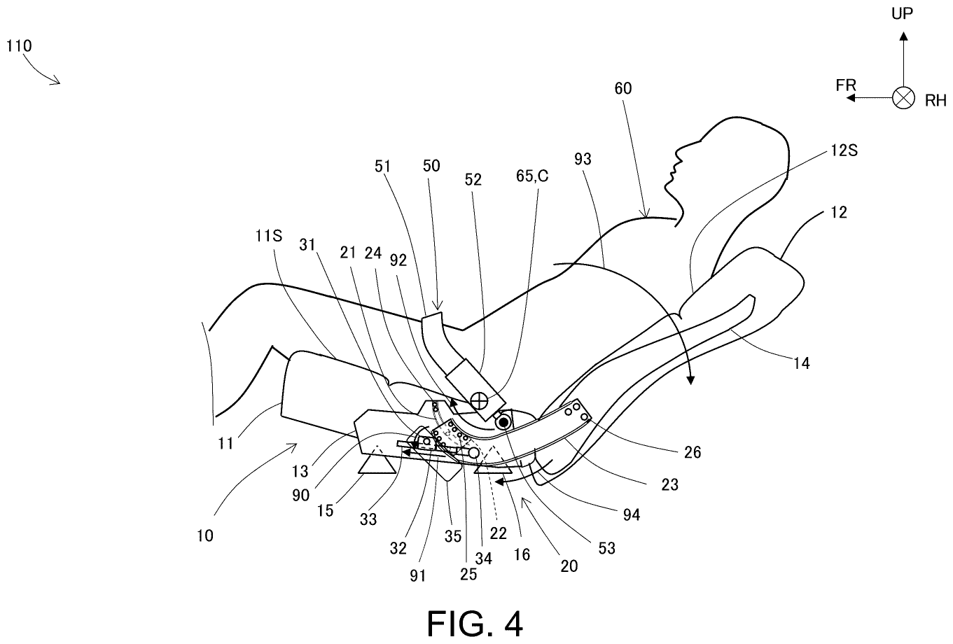

Next, the vehicle seating device 110 of the comparative example will be described with reference to FIG. 4. The vehicle seating device 110 includes a vehicle seat 10 and a seat belt 50. The seat belt 50 includes a belt main body 51, a belt buckle 52, and a belt anchor (not shown). The belt buckle 52 is rotatably fastened to the fastening point 53 of the left side frame 13. The belt anchor is rotatably fastened to a fastening point (not shown) of the right side frame 13.

As shown in FIG. 4, in the vehicle seating device 110, since the belt buckle 52 and the belt anchor are fastened to the left and right side frames 13, the fastening point does not move along with the rearward inclination of the seat back 12. On the other hand, when the seat back 12 tilts backward, the body of the occupant 60 also tilts backward. Therefore, when the seat back 12 tilts backward, the belt main body 51 moves below the abdomen of the occupant 60, and cannot support the upper anterior iliac spine of the occupant 60. Therefore, in the vehicle seating device 110, when a frontal collision occurs in a state where the seat back 12 is inclined rearward, the submarine phenomenon in which the body of the occupant 60 slides down to the front of the vehicle seat 10 may not be sufficiently suppressed.

In contrast, in the vehicle seating device 100 of the embodiment, when the seat back 12 is tilted rearward, the positions of the belt buckle 42 and the belt anchor 44 of the seat belt 40 move according to the tilt angle, and thus the position of the belt main body 41 with respect to the body of the occupant 60 is kept substantially constant. Therefore, the vehicle seating device 100 can support the upper anterior iliac spine of the occupant 60 even in a state where the seat back 12 is tilted backward, and can sufficiently support the occupant 60.

In addition, in the vehicle seating device 100, since the rotation center C of the seat back 12 is set to a position close to the hip point 65 of the occupant 60, when the seat back 12 is tilted backward, it is possible to suppress positional displacement of the head of the occupant 60 with respect to the headrest and curling up of the clothing of the occupant 60.

In the vehicle seating device 100, the curved rail 21 is attached to the side frame 13 such that the center of curvature thereof is located at a position away from the side frame 13 or the bracket 23. Accordingly, it is possible to suppress the occupant 60 seated on the vehicle seat 10 from coming into contact with the reclining mechanism 20.

In the above description, the curved rail 21 is an arc-shaped rail. For example, the curved rail 21 may have a curved shape having a plurality of radii of curvature. In this case, the curved rail 21 has a plurality of centers of curvature, and a plurality of rotation centers C of the seat back 12 can be set. Accordingly, it is possible to perform the reclining operation with a high degree of freedom.

In the above description, the bracket 23 is fixed to the seat back frame 14 by the bolt 26, but is not limited thereto as long as it is integrally provided with the seat back frame 14. For example, a seat back frame assembly in which the seat back frame 14 and the bracket 23 are integrally molded may be used. Further, in the above description, the worm gear is adopted as the gear, but of course, another type of gear may be adopted.

1. A seating device for a vehicle comprising:
a vehicle seat; and
a seat belt for restraining a vehicle occupant seated on the vehicle seat, wherein
the vehicle seat includes,
a side frame configured to support a seat cushion,
a seat back frame configured to support a seat back, and
a reclining mechanism,
the reclining mechanism includes a curved bracket integrally mounted on the seat back frame,
the bracket is configured to move arcuately with respect to the side frame to thereby tilt the seat back rearwardly,
the seat belt includes a belt buckle and a belt anchor, and
the belt buckle and the belt anchor are coupled to the bracket.

2. The seating device for a vehicle according to claim 1, wherein
the reclining mechanism includes a curved rail attached to the side frame,
the bracket is configured to move while being guided by the curved rail, so as to be swung around the center of curvature of the curved rail,
the curved rail is attached to the side frame with the center of curvature being located away from the side frame or the bracket.
